(19) United States
(12) Patent Application Publication
(10) Pub. No.: US 2019/0340608 A1
(43) Pub. Date: Nov. 7, 2019

(54) NOVEL APPLICATION OF BLOCKCHAIN DATA STRUCTURES FOR LIVE AND RECORDED BROADCAST AUDITING

(71) Applicants: JOHN PAUL LINDSAY, SAN FRANCISCO, CA (US); DIEGO MARTIN-ADAN, SAN FRANCISCO, CA (US); FABIANO DIAS GUIMARAIS, NEW YORK, NY (US)

(72) Inventors: JOHN PAUL LINDSAY, MINNEAPOLIS, MN (US); DIEGO MARTIN-ADAN, SEVILLE (ES); FABIANO DIAS GUIMARAIS, SAO PAULO (BR)

(73) Assignee: INWAGE LLC, NEW YORK, NY (US)

(21) Appl. No.: 16/513,878

(22) Filed: Jul. 17, 2019

(51) Int. Cl. G06Q 20/38

(52) U.S. Cl. CPC G06Q 20/389; G06Q 2220/00; G06Q 20/3825; G06Q 20/3827

(57) ABSTRACT

The present invention comprises a novel application of blockchain data structure for broadcast information management generally consisting of an application server with logic for receiving and depositing broadcast information, a private datastore for privately storing information, a translation element for translating information into the language of the blockchain data structure, and a blockchain structure. The blockchain structure is generally composed of cryptographically linked blocks, a tree that bundles transactions, and transactions as the base element with input and output components and a sending function with a cryptographic signature. The present invention therefore allows for four actions: putting to a private datastore, putting to a private datastore with a cryptographic hash to public blockchain data structure, fetching from a private datastore, and fetching directly from a public blockchain data structure. The present invention also includes a design for charging payment by means of a payment request feature of a blockchain data structure for the service of consuming broadcast information comprising a broadcast payment server, broadcast information server, private datastore, and a public blockchain data structure.

### FIELD OF THE INVENTION

The present invention relates to the novel application of a blockchain data structure for auditing live and recorded broadcasts. More particularly, the invention relates to a platform for managing and selling live and recorded broadcasts where the attendees and session information is recorded to a blockchain data structure featuring a peer-to-peer network, asymmetric key cryptography, and a consensus mechanism.

### BACKGROUND

Public blockchains have been a fast growing area of interest for the privacy and security improvements they make on private blockchains and traditional database software. In particular they offer better auditing tools by distributing information among more participants while preserving privacy through cryptographic laws.

Live and Recorded Broadcasts enable creators and consumers to interact closely without being in the same physical location. There has been increased interest in this after the proliferation of smartphones in human culture as well as the result of the monetary costs of physical transportation.

There have been challenges with respect to matching the correct database and information validation technologies for privacy and trust to the types of information shared via live and recorded broadcasts.

### BRIEF SUMMARY OF THE INVENTION

The present invention comprises a novel application of a public blockchain consisting of a permissionless public blockchain featuring a peer-to-peer network, asymmetric key cryptography, and a consensus mechanism which is capable of recording attendee and session information from a live or recorded broadcast.

The attendee information includes identity, timing of attendance and viewing, and location information. The session information includes information from the broadcaster such as identity, timing of broadcast, and location information.

The invention also includes the recording on a public blockchain of the content of the broadcast, both content from the broadcaster and from the viewer. This can include audio, images, and video (moving images) information.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts the basic view of one example of a blockchain data structure which is a component of various embodiments of the present invention.

FIG. 2—FIG. 2 depicts the basic view of one example of a blockchain transaction which is a component of various embodiments of the present invention.

FIG. 3—FIG. 3 depicts the basic view of one example of a design for applying blockchain data structure for broadcast information management which is an embodiment of the present invention.

FIG. 4—FIG. 4 depicts the basic view of one example of a design for charging payment by means of blockchain data structure for the service of consuming broadcast information which is an embodiment of the present invention.

### DETAILED DESCRIPTION OF THE INVENTION

The terminology used herein is for the purpose of describing particular embodiments only and is not intended to be limiting of the invention. As used herein, the term “and/or” includes and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure will not be interpreted as an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Novel applications of blockchain data structures for live and recorded broadcast auditing are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

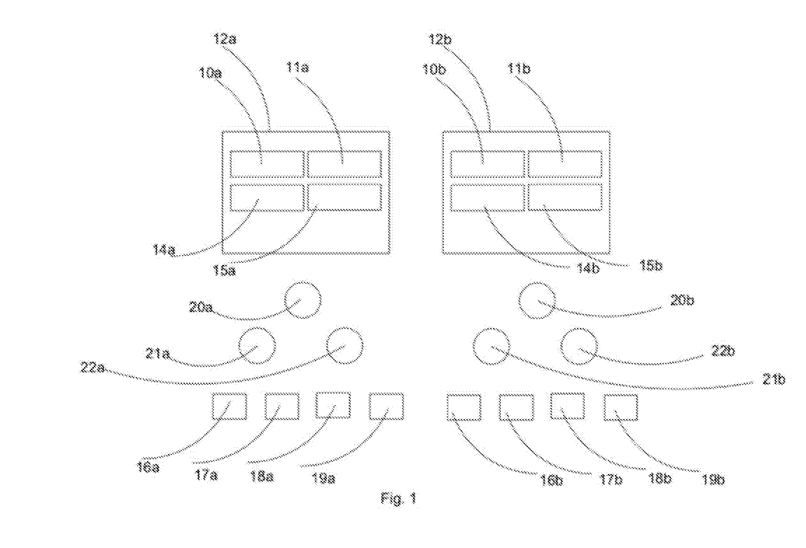

The present invention will now be described by referencing the appended figures representing preferred embodiments. FIG. 1 depicts the basic view of the elements that may comprise a blockchain data structure which is a component of various embodiments of the present invention. In preferred embodiments of the present invention, the configuration is a series of blocks, the first block labeled 12a, and the second block labeled 12b. Within each block there are four components: the hash labeled 10a, the timestamp labeled 11a, the transactions labeled 14a, and the nonce labeled 15a.

The relation between blocks is such that the cryptographic hash of block labeled 12a is the hash labeled 10b of the next block labeled 12b. The transaction components 14a and 14b are themselves derived from cryptographic merkle trees which are composed, respectively, of hashes 20a and 20b, which are themselves composed, respectively, of hashes 21a and 22a, and 21b and 22b, which are themselves composed of transactions, for example, 21a is composed of 16a and 17a, and 22a is composed of 18a and 19a, although there is not necessarily a limit of two transactions at the base of a merkle tree.

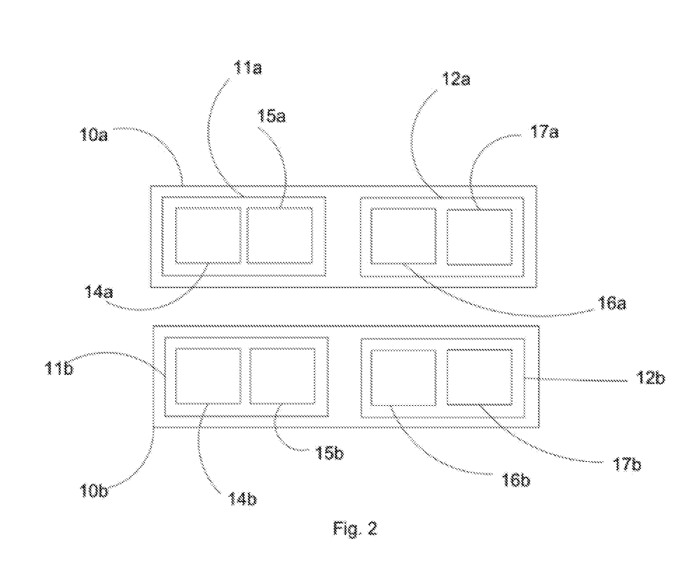

FIG. 2 depicts the basic view of the elements that may comprise a transaction as labeled 16a, 17a, 18a, 19a, 16b, 17b, 18b, and 19b in FIG. 1. In particular the element labeled 10a in FIG. 1 may, for the purpose of this explanation, correspond to element 16a in FIG. 1, and the element labeled 10b in FIG. 1 may, for the purpose of this explanation, correspond to element 16b in FIG. 1.

FIG. 2 shows two transaction elements labeled 10a and 10b. Each transaction element has a transaction input object, labeled 11a and 11b, and a transaction output object, labeled 12a and 12b. Each transaction input object (11a and 11b) and transaction output object (12a and 12b) has a series i.e. list of pairs of value and address objects. In this example the value objects are 14a, 16a, 14b, and 16b, and the address objects are 15a, 17a, 15b, and 17b. So the value address pairs are 14a and 15a, 16a and 17a, 14b and 15b, and 16b and 17b. There is not necessarily a limit of one value address pair in the list of pairs of value and address objects in the transaction input (11a and 11b) and output (12a and 12b) objects.

In the described embodiment of the present invention, information is stored in the value fields 14a, 16a, 14b, and 16b through a number, and location of the information is stored in the address fields 15a, 17a, 15b, and 17b through a public key derived from asymmetric cryptography, also known as public key cryptography. The corresponding private key is stored privately.

The transaction element labeled 10a in FIG. 2, corresponding to transaction element 16a in FIG. 1, can be used to denote the sending of information denoted by value field 14a stored in location denoted by address field 15a into information denoted by value field 16a stored in location denoted by address field 17a.

The sending operation requires a cryptographic signature which bundles the transaction element labeled 10a in FIG. 2 i.e. 16a in FIG. 1 into the cryptographic merkle tree as described above and thereafter into the transaction element 14a of block element 12a in FIG. 1. The previous block (not shown here) is cryptographically hashed into element 10a, as described in section [00016] when describing the relation between blocks. Together with elements 11a and 15a, the block 12a is then publicly and physically broadcasted to be stored publicly and physically by the various participants listening and ready to receive blocks.

The relation between transaction elements is such that the value and address object pairs labeled 16a and 17a within the transaction output object labeled 12a of transaction element labeled 10a become the value and address object pairs labeled, for the sake of example, as 14b and 15b within the transaction input object labeled 11b of transaction element labeled 10b. In the embodiment shown here of the present invention, where the transaction element labeled 10a in FIG. 2 corresponds to transaction element 16a in FIG. 1 and the transaction element labeled 10b in FIG. 2 corresponds to transaction element 16b in FIG. 1, if the value and address object pairs 16a and 17a become the value and address object pairs 14b and 15b, this act of becoming happens after the transaction element object 10b of FIG. 2 (16b of FIG. 1) is signed as described in section [00021].

Because of the computation power required to generate a signature as described in section [00021] due to cryptographic principles, and because each block is related to one another as described in section [00016], as more blocks are generated and received by the participants there is a persistence property of blockchain data structures where once written the information cannot be removed assuming limited adversarial computation power.

The application this invention is using the above described blockchain data structure for is auditing live and recorded broadcasts. Here the value field is the information with respect to the broadcast, and the location field is who is involved in the broadcast.

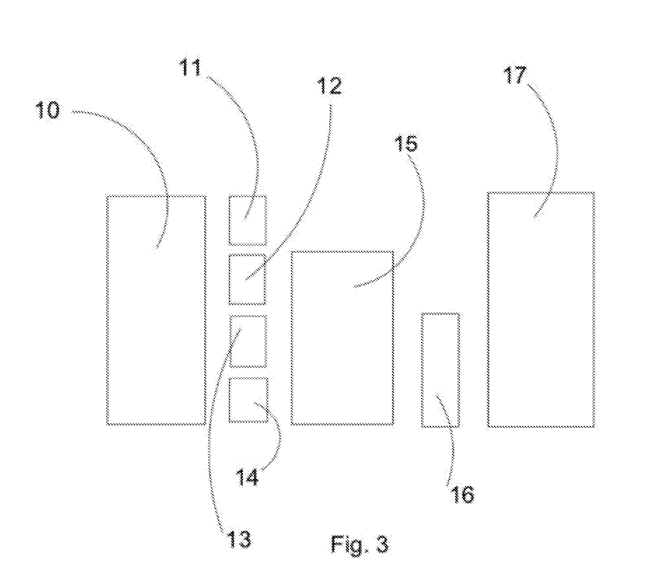

FIG. 3 depicts the elements of one example of a design for applying blockchain data structure for broadcast information management which is an embodiment of the present invention. The application server element, labeled 10, has logic and temporary memory and other standard parts of an application server. The private datastore, labeled 15, stores data in a physical private location. The blockchain data structure, labeled 17, stores data in a public decentralized manner as described above and shown in FIG. 1 and FIG. 2.

The hashing element, labeled 16, translates data from its native form into the language of the blockchain. For example in the blockchain described in FIG. 1 and FIG. 2, the blockchain uses a list of pairs of value and address objects, and so this hashing element, labeled 16, translates broadcast information, roughly speaking, into lists of pairs of value and address objects.

The current example of the present invention requires actions 11, 12, 13, and 14 to be taken by the application server, labeled 10, to interact with elements 15, 16, and 17. Actions 12 and 14 are putting actions i.e. putting information. Actions 11 and 13 are fetching actions i.e. taking information.

Action 12 is a private put and so it puts information only to the private datastore, labeled 15. Action 14 is a public put and so it puts information to the public blockchain data structure, labeled 17. The public put operations happens by first putting information into the private datastore, labeled 15, and then putting information from there to the hashing element, labeled 16, and from there to the public blockchain data structure, labeled 17.

Action 13 is a private fetch and so it fetches information only from the private datastore, labeled 15. This information can include both information only privately put (action 12) or also information publicly put (action 14). Action 11 is a public fetch and so it fetches information directly from the public blockchain data structure, labeled 17.

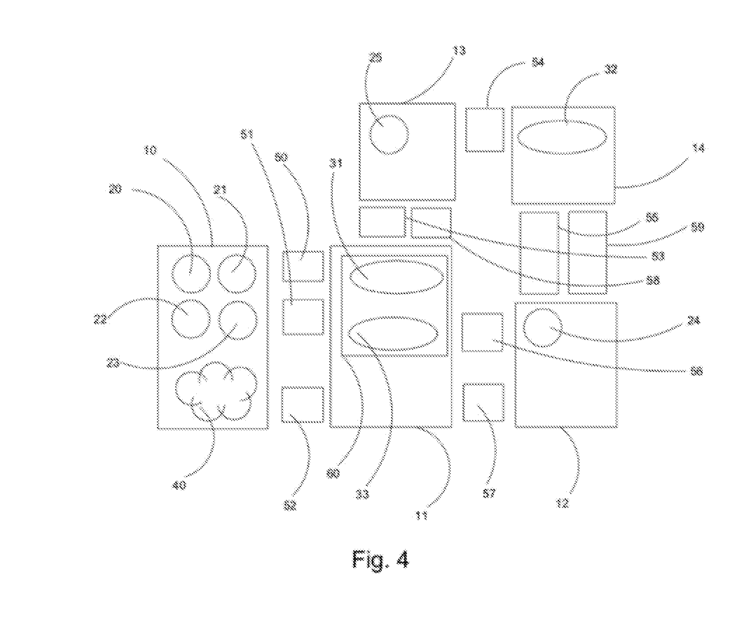

FIG. 4 depicts the basic view of one example of a design for charging payment by means of blockchain data structure for the service of consuming broadcast information which is an embodiment of the present invention. The broadcast information server (BIS), labeled 10, is the source of the broadcast, which fetches and puts information into and out of a private datastore and if relevant the public blockchain, as described in FIG. 3. The broadcast payment server (BPS), labeled 11, does logic and exchanges information in between the BIS and the private datastore, labeled 13, the public blockchain data structure, labeled 14, and the broadcast client device (BCD), labeled 12. The goal of the process described in FIG. 4 is to generate a broadcast session which is defined by an access url link as well as access credentials for viewing the session through the access url link, which are both labeled by object 40. The specific details of this access url link generation mechanism are not described because it will be evident to one skilled in the art that the present invention may be practiced without these specific details.

The key data objects within the BIS, labeled 10, are the duration of the broadcast, labeled 20, the price per time, labeled 21, the unique broadcaster id, labeled 22, and the unique session id, labeled 23. The key data object within the private datastore, labeled 13, is the private cryptography key that corresponds to the public cryptography key of an address on the public blockchain, as described for example in address object 15a of the value, address pair 11a in FIG. 2. The key data object in the broadcast client device (BCD), labeled 12, is the unique client id, labeled 24.

The first derived data object within the BPS, labeled 11, is the payment request amount, labeled 31, which is derived from the broadcast duration object, labeled 20, and the price per time, labeled 21. The second derived data object within the BPS, labeled 11, is the payment request address, labeled 33. These two data objects make up a payment request object, labeled 60, which is sufficient information for a client to fulfill the request through a public blockchain transaction, as described in FIG. 1 and FIG. 2.

The payment request address is derived from taking the unique broadcaster id, labeled 22, the unique session id, labeled 23, the private cryptography key with the private datastore, labeled 13, and the unique consumer id, labeled 12, and using a standard cryptographic deterministic algorithm, deriving a unique private and public cryptographic key pair that is valid only for this payment request. The public cryptographic address of the pair, labeled 32, will be visible on the public blockchain data structure, labeled 14, in the form of an address within a value, address pair object, for example in address object 15a of the value, address pair 11a in FIG. 2, after the payment request has been paid in a public blockchain transaction, as described in FIG. 1 and FIG. 2.

The present illustration of the invention describes the requesting of an access url link as well as access credentials for viewing the broadcast session through the access url link and FIG. 4 shows the basic view of one example of a design for charging payment by means of blockchain data structure for this access url link and associate credentials. The process first requires the BCD, labeled 12, to receive a payment request object, labeled 60, from the BPS, labeled 11. This payment request object requesting action is shown by object 56.

In order to fulfill action 56, the design requires actions 50, 51, 52 to be taken by the BPS, labeled 11, in relation to the BIS, labeled 10, and action 53 to be taken by the BPS, labeled 11, in relation to the private datastore, labeled 13. The first action, 50, is a fetching request from the BPS, labeled 11, to the BIS, labeled 10, to retrieve the duration of the broadcast, labeled 20, and the price per time, labeled 21. This allows the BPS, labeled 11, to generate the payment request amount, labeled 31. The second action, 51, is a fetching request from the BPS, labeled 11, to the BIS, labeled 10, to retrieve the unique broadcaster id, labeled 22, and the unique session id, labeled 23. The third action, 53, is a fetching request from the BPS, labeled 11, to the private datastore, labeled 13, to retrieve the private cryptographic key, or a derivation therefrom. These two actions, combined with the payment request object requesting action, shown by object 56, where the BCD, labeled 12, is supplying a unique consumer id, labeled 24, allow the BPS, labeled 12, to generate the payment request address, labeled 33, the process of which is described in section [00036].

Then the BCD, labeled 12 must fulfill the payment request object through a public blockchain transaction, as defined in FIG. 1 and FIG. 2 to the public cryptographic address, labeled 32, visible on the public blockchain data structure, labeled 14. This payment request fulfilling action is shown by object 55.

The blockchain transaction representing the fulfillment of the payment request object, labeled 60, is visible by querying of the blockchain data structure, labeled 14, from the BCD, labeled 12, by means of action 59 which queries the public data structure, labeled 14, for whether sufficient value is in the value, address pair of the cryptographic address, labeled 32. After payment request fulfillment, the BCD, labeled 12, is now able to request the access url information, labeled 40. This access url information object requesting action is shown by object 57.

In order to fulfill the access url information object requesting action 57, the BPS, labeled 11, first queries the blockchain data structure, labeled 14, by means of action 58 which requests action 54 to be taken by the private datastore to query the public data structure, labeled 14, for whether sufficient value is in the value, address pair of the cryptographic address, labeled 32. The BPS, labeled 11, then queries the BIS, labeled 10, via action 52, for the access url information, labeled 40.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A blockchain data structure for storing broadcast information the data structure comprising:
a. Blocks cryptographically hashed from the previous
b. The transaction hash component being cryptographically derived from a merkle
c. tree of transactions
d. The transactions having an input and output and a sending function with a
e. cryptographic signature

2. A broadcast information flow design that takes information from an application server and uses a private datastore and a translation element to enable four actions namely:
a. Putting action to private datastore
b. Putting action to private datastore with hash to public blockchain data structure
c. Fetching action from private datastore
d. Fetching action direct from public blockchain data structure

3. A design for charging payment by means of blockchain data structure for the service of consuming broadcast information comprising:
a. Broadcast client device (BCD) capable of interacting with a public blockchain data structure as well as consuming a broadcast access url
b. Broadcast payment server (BPS) capable of generating a blockchain payment request
c. Broadcast information server (BIS) capable of creating an access url to a broadcast
d. Private datastore
e. Public blockchain data structure
